(19) United States
(12) Patent Application Publication
(10) Pub. No.: US 2026/0099565 A1
(43) Pub. Date: Apr. 9, 2026

(54) NON-TRANSITORY COMPUTER-READABLE MEDIUM, CALCULATION METHOD, AND INFORMATION PROCESSING DEVICE

(71) Applicant: Fujitsu Limited, Kawasaki-shi (JP)

(72) Inventor: Yuma ICHIKAWA, Kawasaki (JP)

(73) Assignee: Fujitsu Limited, Kawasaki-shi (JP)

(21) Appl. No.: 19/348,828

(22) Filed: Oct. 3, 2025

(30) Foreign Application Priority Data
Oct. 7, 2024 (JP) 2024-175796

(51) Int. Cl. G06F 17/11; G06N 20/00

(52) U.S. Cl. CPC G06F 17/11; G06N 20/00

(57) ABSTRACT

There is provided a non-transitory computer-readable medium storing a calculation program for causing a computer to execute a process. The process includes, in a cost function in a search process that performs a search by incorporating continuous relaxation into a discrete optimization problem, in which each element of a matrix obtained by relaxing discrete variables to be optimized into a continuous matrix is a solution of a plurality of discrete optimization problems, outputting a solution of a discrete optimization problem using solutions of the plurality of discrete optimization problems obtained by training a machine learning model by applying a perturbation to the plurality of discrete optimization problems.

### CROSS-REFERENCE TO RELATED APPLICATION

This application is based upon and claims the benefit of priority of Japanese Patent Application No. 2024-175796 filed on Oct. 7, 2024, the entire contents of which are incorporated herein by reference.

### FIELD

A certain aspect of the present embodiments relates to a non-transitory computer-readable medium, a calculation method, and an information processing device.

### BACKGROUND

Technologies for optimizing complex combinations have been disclosed (see, for example, Schuetz, M. J., Brubaker, J. K., and Katzgraber, H. G. (2022a). Combinatorial optimization with physics-inspired graph neural networks. Nature Machine Intelligence, 4 (4): 367-377, and Schuetz, M. J., Brubaker, J. K., Zhu, Z., and Katzgraber, H. G. (2022b). Graph coloring with physics-inspired graph neural networks. Physical Review Research, 4 (4): 043131.)

### SUMMARY

According to an aspect of the present disclosure, there is provided a non-transitory computer-readable medium storing a calculation program for causing a computer to execute a process, the process including: in a cost function in a search process that performs a search by incorporating continuous relaxation into a discrete optimization problem, in which each element of a matrix obtained by relaxing discrete variables to be optimized into a continuous matrix is a solution of a plurality of discrete optimization problems, outputting a solution of a discrete optimization problem using solutions of the plurality of discrete optimization problems obtained by training a machine learning model by applying a perturbation to the plurality of discrete optimization problems.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating perturbations;

FIG. 2 is a diagram illustrating verification results for solution principle;

FIG. 3A is a functional block diagram of an overall configuration of an information processing device according to an embodiment;

FIG. 3B is a hardware configuration diagram of an information processing device;

FIG. 4 is a flowchart of an example of an operation of an information processing device during machine learning; and

FIG. 5 is a flowchart of an example of an operation of an information processing device when outputting an approximate solution to an optimization problem using results of machine learning model.

### DESCRIPTION OF EMBODIMENTS

In combinatorial optimization, it is considered to search for optimal solutions using a continuous relaxation simulated method that uses a machine learning model. However, it is difficult to find solutions for multiple problems. Therefore, it is considered to relax discrete variables into a continuous matrix and find solutions for multiple problem instances. However, it is difficult to find solutions for unknown problem instances.

Optimization problems exist in a variety of industries, including manufacturing and distribution. Combinatorial optimization problems, which involve optimizing combinations, are particularly important in the field of optimization. Combinatorial optimization problems are applied in a variety of fields, including transportation, logistics, communications, or finance.

Combinatorial optimization is an optimization problem formulated as expressed in the following formula (1). In the formula (1), “C” is a parameter that characterizes the problem. Note that in the formula (1), “x” is a vector represented by 0 and 1 and has N elements. Generally, in f(x;A), “x” represents the variable to be optimized, and “A” represents a constant that is not to be optimized. Therefore, in the formula (1), the variable vector x is the variable to be optimized, and the parameter C is a constant.

$$\begin{matrix}[ Formula 1 ] & \\ {min}_{x ∈ {\{ 0 , 1 \}}^{N}} f ( x ; C ) & ( 1 )\end{matrix}$$

In recent years, continuous relaxation methods have been developed as an alternative to discrete optimization problems. The continuous relaxation method is a technique that, instead of solving a discrete optimization problem, relaxes the discrete optimization problem and solves a corresponding continuous optimization problem. A continuous optimization problem can be expressed as in the following formula (2). In the formula (2), [0, 1]^{N} represents an N-dimensional hypercubic lattice with values of 0 or 1. In the formula (2), the variable vector p is the variable to be optimized.

$$\begin{matrix}[ Formula 2 ] & \\ {min}_{p ∈ {[ 0 , 1 ]}^{N}} f ( p ; C ) & ( 2 )\end{matrix}$$

However, even with the continuous relaxation method, the loss landscape may still be complex. Furthermore, the relaxed optimal solution may differ significantly from the original optimal solution.

Next, the combination of unsupervised learning and combinatorial optimization in the continuous relaxation method will be described. In this case, the above variable vector p is characterized by a deep neural network (DNN) model, and optimization is performed using the loss function in the following formula (3). In this case, the optimization problem for the continuously relaxed variable p is reduced to optimizing the DNN parameter θ.

$$\begin{matrix}[ Formula 3 ] & \\ {min}_{θ} f ( {p}_{θ} ; C ) & ( 3 )\end{matrix}$$

This optimization method may output a continuous solution. A continuous solution here is a value greater than 0 and less than 1. If a continuous solution is output, it becomes necessary to round the solution to “1” or “0” using thresholding, for example, by setting values greater than ½ to “1” and values less than ½ to “0”. Furthermore, even with a greedy algorithm, solving the problem becomes difficult once the region where a good solution can be obtained is exceeded. Transfer learning is also difficult.

For this reason, the CRA-PI-ML Solver may be considered. The CRA-PI-ML Solver introduces a penalty term into the cost function, as expressed by the following formula (4). The penalty term is part of the following formula (5) and is a loss term used to control the degree of continuity and discreteness.

$$\begin{matrix}[ Formula 4 ] & \\ \hat{r} ( θ ) = f ( {p}_{θ} ; C ) + λ {\sum }_{i = 1}^{N} ( {( 2 {p}_{θ , i} - 1 )}^{2} - 1 ) & ( 4 )\end{matrix}$$

$$\begin{matrix}[ Formula 5 ] & \\ {\sum }_{i = 1}^{N} ( {( 2 {p}_{θ , i} - 1 )}^{2} - 1 ) & ( 5 )\end{matrix}$$

“λ” is a parameter that controls the penalty term in the formula (5), and is a hyperparameter that controls the degree of continuity and discreteness. For example, if λ<0, continuous solutions are preferred, and if λ>0, discrete solutions are preferred.

As machine learning progresses, the hyperparameter λ is gradually changed from a negative value λ(0)<0 to a positive value λ(T)>0. As a result, the penalty term changes from one that reduces loss the more continuous the discrete vector p is to one that increases loss the more continuous the discrete vector pis. For example, if λ is −∞, the output solution will be ½. If λ is +∞, the output solution will be a discrete variable of 0 or 1. This method is sometimes called continuous relaxation simulated annealing method. By controlling in this way, machine learning ends when the discrete vector becomes mostly discrete.

However, the CRA-PI-ML Solver only outputs a single solution. Therefore, the CTRA-PI-GNN Solver may be considered. In the CTRA-PI-GNN Solver, discrete variables are relaxed to a hypercube matrix P^{θ}∈[0,1]^{N×M}. The loss function in the following formula (6) is optimized so that each column P^{θ} of the continuous matrix P^{θ} becomes a solution to the optimization problem. Note that P^{θ}_{:,m} refers to the m-th column vector of the continuous matrix P^{θ}. This optimization makes it possible to simultaneously obtain solutions to multiple problems in almost the same computational time as the CRA-PI-ML Solver.

$$\begin{matrix}[ Formula 6 ] & \\ \hat{R} ( θ ; Q ( γ ) ) = {\sum }_{m = 1}^{M} f ( {P}_{: , m}^{θ} ; {C}_{S} ) + λ {\sum }_{i = 1}^{N} ( {( 2 {P}_{i , m}^{θ} - 1 )}^{2} - 1 ) & ( 6 )\end{matrix}$$

However, the above CTRA-PI-GNN Solver has difficulty in solving unknown problem instances.

In the following embodiment, an example in which a solution can be found for an unknown problem instance will be described.

### EMBODIMENT

First, the principle of this embodiment will be described. In this embodiment, an unknown optimization problem C_{new} is inferred without learning using a CTRA-PI-GNN solver that solved a set of S problem instances represented by the following formula (7).

$$\begin{matrix}[ Formula 7 ] & \\ {C}_{s} = {\{ {C}_{s} \}}_{s = 1}^{S} & ( 7 )\end{matrix}$$

Specifically, during machine learning, when the gradient method is used to update model parameters, a perturbation operator Ψₛ is applied to the set of problem instances represented by the formula (7) above to optimize the loss function represented by the following formula (8). Note that the perturbation operator Ψₛ generalizes the slight random changes made to the parameter Cₛ that characterizes the problem. Taking graph optimization as an example, the perturbation operator is generalized to include node and edge perturbations in addition to noise perturbations. It is preferable to construct the perturbation operator so that a different perturbation is applied for each gradient update.

$$\begin{matrix}[ Equation 8 ] & \\ \hat{R} ( θ ; {C}_{s} ) = {\sum }_{s = 1}^{S} f ( {P}_{: , s}^{θ} ; {Ψ}_{s} {C}_{S} ) + λ {\sum }_{i = 1}^{N} ( {( 2 {P}_{i , m}^{θ} - 1 )}^{2} - 1 ) & ( 8 )\end{matrix}$$

Next, for each of the S columns of the output result P^{θ} obtained as the optimization solution of the formula (8), the cost function of the following formula (9) for the new instance m* is calculated, and the best solution from the multiple solutions obtained is taken as the approximate solution. In this embodiment, the solution that minimizes the cost function, as expressed in the following formula (10), is taken as the approximate solution for the unknown C_{new}.

$$\begin{matrix}[ Equation 9 ] & \\ {\{ f ( {P}_{: , s}^{θ} ; {C}_{new} ) \}}_{s = 1}^{S} & ( 9 )\end{matrix}$$

$$\begin{matrix}[ Equation 10 ] & \\ {P}_{: , {m}^{*}}^{θ} , {m}^{*} = arg min {\{ f ( {P}_{: , m}^{θ} ; {C}_{new} ) \}}_{m = 1}^{M} & ( 10 )\end{matrix}$$

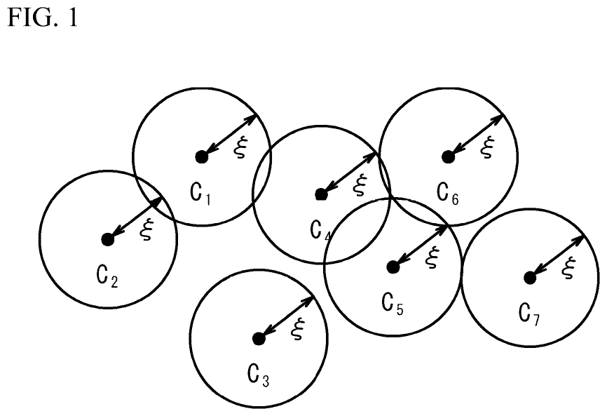

Here, a specific example of the perturbation operator will be described. For simplicity's sake, if the parameter Cₛ of the problem instance, such as the price in the knapsack problem, is a constant, one example is the noising operator defined as in the following formula (11). As an example, in the formula (11), N(0,I) represents a Gaussian distribution. Intuitively, each column of the CTRA-PI-GNN output generalizes to the range illustrated in FIG. 1. For each C, a good solution is obtained within the range ε. For example, if C_{new} is close to one of the Cₛ, the solution for that C will be adopted.

$$\begin{matrix}[ Equation 11 ] & \\ {ψ}_{s} ( {C}_{s} ) = {C}_{s} + ξ , ξ = N ( 0 , I ) & ( 11 )\end{matrix}$$

Note that the wider the range of noise provided by the perturbation operator, the worse the quality of the solution. For example, if S=1 (single shot) and the noise is sufficiently large, a solution specialized for any problem may not be obtained. For example, a random solution (a solution in which 0 and 1 are mixed with a probability of ½) may be selected. To solve this issue, a preferred approach is to handle multiple instances using multi-shot, as illustrated in the graph in FIG. 1, and generalize only the neighborhood.

Here, the reason why it is difficult to apply perturbation-based generalization, as in this embodiment, to the combination of supervised learning and combinatorial optimization will be described. First, the details of the combination of supervised learning and combinatorial optimization will be described.

When combining supervised learning and combinatorial optimization, various instances and their approximate solutions D={C_{μ}, x_{μ}} are prepared. Next, a machine learning model is trained for each instance so that C_{μ}→x_{μ}. Next, an approximate solution x_{new} is obtained for an unknown instance C_{new} using the trained machine learning model.

Here, the problems of the supervised learning will be summarized. The supervised learning does not generalize well, and good solutions are often only output near the training data. Furthermore, obtaining training data is difficult. For example, it is necessary to obtain approximate solutions for multiple instances in advance.

Next, the reason why perturbation-based generalization is inapplicable to supervised learning will be described. In the supervised learning, perturbations are applied to create a new approximate solution x for each instance ΦₛCₛ. This computational cost is one reason why perturbation-based generalization has not been adopted.

For these reasons, it is difficult to apply perturbation-based generalization, as in this embodiment, to a combination of the supervised learning and the combinatorial optimization.

Next, the above solution principle will be verified. Specifically, a weighted MaxCut problem on a Random Regular Graph with degree d=20 and 100 nodes will be verified. A degree d=20 and 100 nodes means that there are 100 nodes, and each node is randomly connected to 20 other nodes. In the following formula (12), Cᵢⱼ represents the weighted adjacency matrix.

$$\begin{matrix}[ Formula 12 ] & \\ f ( x ; C ) = {\sum }_{i < j} {C}_{ij} ( 2 {x}_{i} {x}_{j} - {x}_{i} - {x}_{j} ) & ( 12 )\end{matrix}$$

For the 1,000 problem instances in the following formula (13), weights are generated uniformly and randomly from [−1, 1, 2, 3]. For the instance C_{new}, weights are generated uniformly and randomly from [−1, 1, 2].

$$\begin{matrix}[ Formula 13 ] & \\ {C}_{S} = {\{ {C}_{s} \}}_{s = 1}^{1000} & ( 13 )\end{matrix}$$

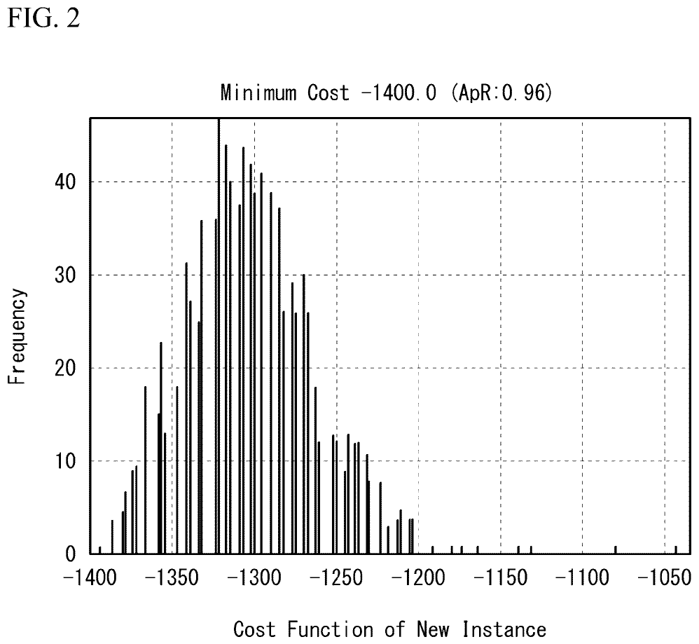

ApR is the ratio of the solution x₁ₛₕₒₜ obtained using the continuous relaxation simulated annealing method, which uses the formula (4) as the loss function, as expressed in the following formula (14). FIG. 2 expresses a histogram of the following formula (15).

$$\begin{matrix}[ Formula 14 ] & \\ ApR = \frac{f ( {P}_{: , s}^{θ} ; {C}_{new} )}{f ( {x}_{1 shot} ; {C}_{new} )} & ( 14 )\end{matrix}$$

$$\begin{matrix}[ Formula 15 ] & \\ {\{ f ( {P}_{: , s}^{θ} ; {C}_{new} ) \}}_{s = 1}^{1000} & ( 15 )\end{matrix}$$

The ApR result was 0.960, confirming that a solution can be found for unknown problem instances.

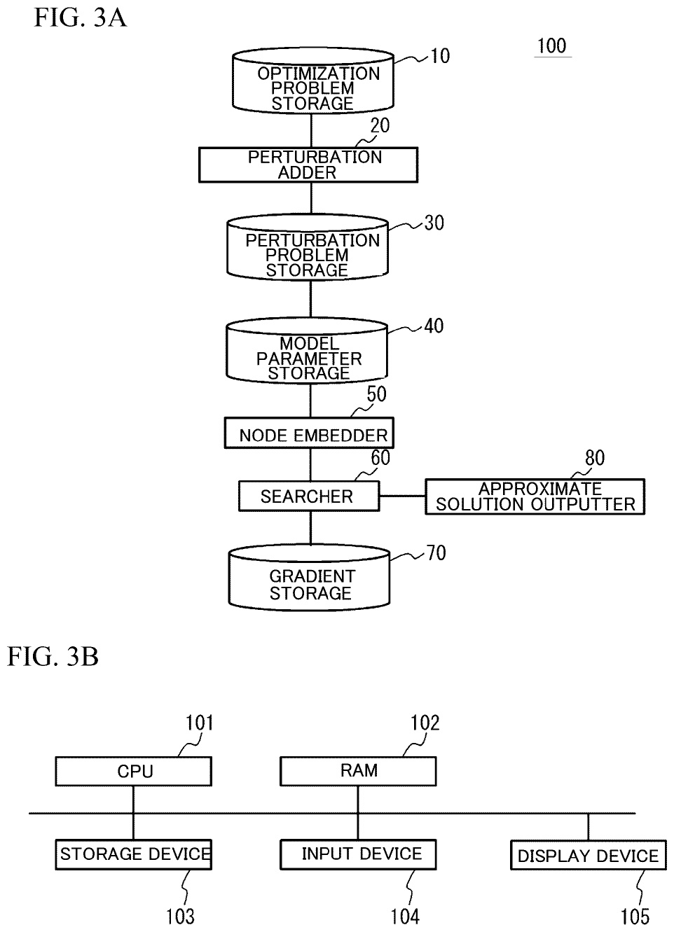

Next, the device configuration for implementing the above solution principle will be described. FIG. 3A is a functional block diagram of the overall configuration of an information processing device 100 according to the embodiment. The information processing device 100 is, for example, a server for optimization processing. As illustrated in FIG. 3A, the information processing device 100 functions as an optimization problem storage 10, a perturbation adder 20, a perturbation problem storage 30, a model parameter storage 40, a node embedder 50, a searcher 60, a gradient storage 70, and an approximate solution outputter 80. The information processing device 100 functions as a machine learning device during machine learning, and as a determination device during determination.

FIG. 3B is a hardware configuration diagram of the information processing device 100. As illustrated in FIG. 3B, the information processing device 100 includes a CPU 101, a RAM 102, a storage device 103, an input device 104, a display device 105, and the like.

The CPU 101 is a central processing unit. The CPU 101 includes one or more cores. The RAM (Random Access Memory) 102 is a volatile memory that temporarily stores the program executed by the CPU 101 and the data processed by the CPU 101. The storage device 103 is a non-volatile storage device. For example, a ROM (Read Only Memory), a solid state drive (SSD) such as a flash memory, or a hard disk driven by a hard disk drive can be used as the storage device 103. The storage device 103 stores a machine learning program and a determination program. The input device 104 is a device for a user to input necessary information, such as a keyboard or a mouse. The display device 105 is a display device that displays the sampling results output by the approximate solution outputter 80 on a screen. Each part of the information processing device 100 is realized by the CPU 101 executing the calculation program or the machine learning program. Note that each part of the information processing device 100 may be hardware such as a dedicated circuit.

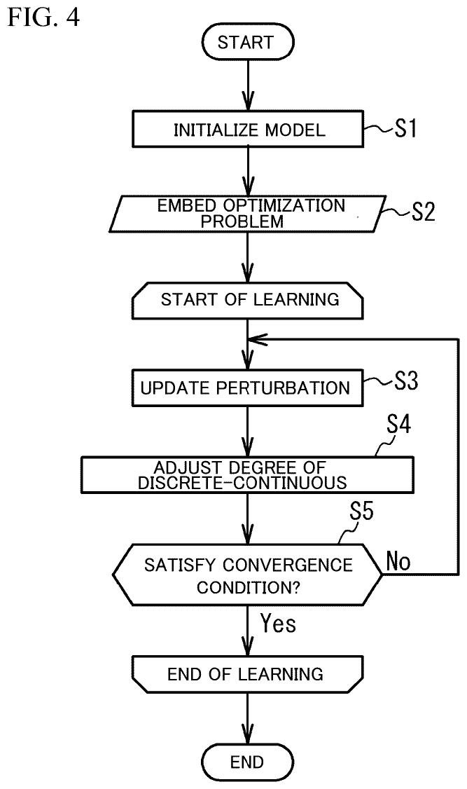

FIG. 4 is a flowchart illustrating an example of the operation of the information processing device 100 during machine learning. As illustrated in FIG. 4, the searcher 60 initializes the model (step S1). Specifically, the searcher 60 sets the model parameters stored in the model parameter storage 40 to predetermined initial values.

Next, the node embedder 50 embeds a set of multiple problem instances Cₛ stored in the optimization problem storage 10 (step S2). Specifically, the perturbation adder 20 first adds the perturbation Φₛ expressed by the above formula (11) to each problem instance Cₛ. Each perturbed problem instance ΦₛCₛ with the perturbation Φₛ added is stored in the perturbation problem storage 30. Next, the node embedder 50 embeds the problem instances stored in the perturbation problem storage 30. As a result, the loss function expressed by the above formula (8) is obtained.

Next, the searcher 60 updates the model parameters using the gradient method. At the same time, the perturbation adder 20 also updates the perturbation Φ (step S3). The first time step S3 is executed, the model parameters are not updated. Therefore, the first time step S3 is executed, the perturbation Φ is not updated either.

Next, the searcher 60 adjusts the degree of continuity and discreteness (step S4). Specifically, each time step S4 is repeated, the searcher 60 gradually changes the hyperparameter λ in the formula (8) from a negative value λ(0)<0 to a positive value λ(T)>0, and calculates the loss function.

Next, the searcher 60 determines whether the convergence condition is met (step S5). For example, it is determined whether the loss function in the formula (8) above no longer becomes smaller than a specified value, even when step S4 is repeatedly executed. If step S5 returns “No,” execution resumes from step S3.

If step S5 returns “Yes,” execution of the flowchart ends. In this case, the model parameter storage 40 stores the model parameters that result in the smallest loss function.

The machine learning illustrated in FIG. 4 results in a machine learning model that minimizes the loss function of the formula (8) above. The machine learning model (model parameters) is stored in the model parameter storage 40.

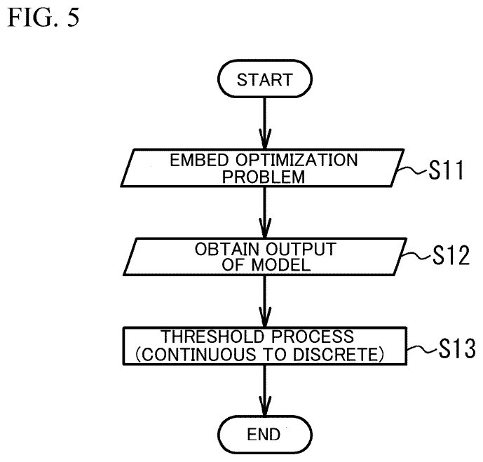

FIG. 5 is a flowchart illustrating an example of the operation of the information processing device 100 when outputting an approximate solution to an optimization problem using the results of the machine learning model obtained by the machine learning illustrated in FIG. 4. As illustrated in FIG. 5, the node embedder 50 embeds the optimization problem (step S11).

Next, the approximate solution outputter 80 obtains the output of the machine learning model (step S12).

Next, the approximate solution outputter 80 calculates the cost function of the formula (9) above for the new instance m* for each column of the output result P^{θ} obtained as the optimization solution of the formula (8) above, and outputs the formula (10) above as an approximate solution for the unknown C_{new} (step S13).

One example of an optimization target to which the above-described embodiment can be applied is an optimization problem that uses a graph. Optimization problems that use a graph are not particularly limited, but an example is an energy transportation problem. Furthermore, the above-described embodiment can also be applied to optimization problems that do not use a graph as the optimization target. Optimization problems that do not use a graph are also not particularly limited, but an example is a corporate scheduling problem.

In the above-described embodiments, the approximate solution outputter 80 is an example of an outputter configured to, in a cost function in a search process that performs a search by incorporating continuous relaxation into a discrete optimization problem, in which each element of a matrix obtained by relaxing discrete variables to be optimized into a continuous matrix is a solution of a plurality of discrete optimization problems, output a solution of a discrete optimization problem using solutions of the plurality of discrete optimization problems obtained by training a machine learning model by applying a perturbation to the plurality of discrete optimization problems.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A non-transitory computer-readable medium storing a calculation program for causing a computer to execute a process, the process comprising:
in a cost function in a search process that performs a search by incorporating continuous relaxation into a discrete optimization problem, in which each element of a matrix obtained by relaxing discrete variables to be optimized into a continuous matrix is a solution of a plurality of discrete optimization problems, outputting a solution of a discrete optimization problem using solutions of the plurality of discrete optimization problems obtained by training a machine learning model by applying a perturbation to the plurality of discrete optimization problems.

2. The non-transitory computer-readable medium according to claim 1,
wherein the machine learning model is trained by using a loss term that corresponds to a degree of continuity and discreteness of variables to be optimized and by changing the loss term as the search process progresses.

3. The non-transitory computer-readable medium according to claim 2,
wherein the machine learning model is trained by changing the loss term as the search process progresses from one that results in a smaller loss the more continuous the variable is to one that results in a larger loss the more continuous the variable is.

4. A calculation method implemented by a computer, the method comprising:
in a cost function in a search process that performs a search by incorporating continuous relaxation into a discrete optimization problem, in which each element of a matrix obtained by relaxing discrete variables to be optimized into a continuous matrix is a solution of a plurality of discrete optimization problems, outputting a solution of a discrete optimization problem using solutions of the plurality of discrete optimization problems obtained by training a machine learning model by applying a perturbation to the plurality of discrete optimization problems.

5. The method according to claim 4,
wherein the machine learning model is trained by using a loss term that corresponds to a degree of continuity and discreteness of variables to be optimized and by changing the loss term as the search process progresses.

6. The method according to claim 5,
wherein the machine learning model is trained by changing the loss term as the search process progresses from one that results in a smaller loss the more continuous the variable is to one that results in a larger loss the more continuous the variable is.

7. An information processing device comprising:
a memory; and
a processor coupled to the memory and the processor configured to execute a process, the process comprising:
in a cost function in a search process that performs a search by incorporating continuous relaxation into a discrete optimization problem, in which each element of a matrix obtained by relaxing discrete variables to be optimized into a continuous matrix is a solution of a plurality of discrete optimization problems, outputting a solution of a discrete optimization problem using solutions of the plurality of discrete optimization problems obtained by training a machine learning model by applying a perturbation to the plurality of discrete optimization problems.

8. The information processing device according to claim 7,
wherein the machine learning model is trained by using a loss term that corresponds to a degree of continuity and discreteness of variables to be optimized and by changing the loss term as the search process progresses.

9. The information processing device according to claim 8,
wherein the machine learning model is trained by changing the loss term as the search process progresses from one that results in a smaller loss the more continuous the variable is to one that results in a larger loss the more continuous the variable is.
